(19) United States
(12) Patent Application Publication
(10) Pub. No.: US 2004/0168493 A1
(43) Pub. Date: Sep. 2, 2004

(54) Urea-Formaldehyde Plant Nutrient Solution Containing High Levels of Slow Release Nitrogen

(75) Inventors: Michael Hojjatie, Tucson, AZ (US); Harry Charles Kominski III, Phoenix, AZ (US); Dean Abrams, Tucson, AZ (US)

Correspondence Address: BANNER & WITCOFF, 1001 G STREET N W, SUITE 1100, WASHINGTON, DC, 20001, US

(73) Assignee: TESSENDERLO KERLEY, INC., Phoenix, AZ (US)

(21) Appl. No.: 10/248,892

(22) Filed: Feb. 27, 2003

(51) Int. Cl. C05C 9/00

(52) U.S. Cl. 71/30

(57) ABSTRACT

The present invention provides a one-stage method of preparing a urea-formaldehyde plant nutrient solution with high percentage of Slow Release Nitrogen (SRN) moiety and low amounts of methylol by-products. A solution of formalin is reacted with urea in the presence of small amount of alkaline material to maintain a pH greater than 7. After the urea has dissolved, an ammonia reactant is added to the reaction mixture. The reaction mixture is exothermically (and, if needed, externally) heated to at least about 90° C. and held for about 70-75 minutes, during which a calculated amount of alkaline material is added, typically in three portions over the first 45 minutes of the 70-75 minute period.

### BACKGROUND OF INVENTION

1. Field of the Invention

The present invention is directed to plant nutrient solutions and, more particularly, to urea-formaldehyde plant nutrient solutions for slowly releasing nitrogen.

2. Description of Related Art

Urea-formaldehyde (UF) condensation products, commonly known as urea forms, have been used for many years as source of slow- and controlled-release plant food nitrogen. Urea-formaldehyde concentrate solutions have been used in the resin and plant nutrient industries for many years. In general, feed material molar ratio, pH, and temperature are the critical controlling parameters in the formation of resins and liquid plant nutrients prepared by the reaction of urea and formaldehyde. A urea molecule behaves like an amino acid amide molecule due to the fact that it reacts in the tautomeric iso-urea form in which the two nitrogen atom groups plainly are differentiated as shown in FIG. 2.

The NH₂ group in this structure would react as an amine, whereas the NH group reacts as an imide forming only simple monomethylol derivatives or methylene-bis derivatives. Monomethylol urea (MMU), dimethylol urea (DMU), and methylene diurea (MDU) form the reaction of urea and formaldehyde. The liquid-based products typically contain a substantial number of some of these urea-formaldehyde reaction products. MMU, DMU, and MDU have limited solubility in water. Excess amounts of these materials will precipitate upon storage. Such by-products are a primary cause of solution cloudiness and formation of deposits during storage. In addition, the products derived from the reaction of urea and formaldehyde may contain substantial unreacted urea, due to improper manufacturing.

Urea contains about 46% by weight of available nitrogen and is commonly used as plant nutrient. Urea is very soluble in water and quickly provides the plants with its available nitrogen in whatever form, either liquid or solid. Formulated urea based plant nutrients have been used to provide the nitrogen to the soil slowly and to avoid phytotoxicity and burning of the plants in the case where too much plant nutrient is used.

A substantial body of literature exists for the production of water-soluble urea formaldehyde reaction products, suitable as plant nutrients. For example, Kealy et al., in U.S. Pat. Nos. 2,955,390, 3, 119,683, and 3,235,370, describes the manufacturing of a urea form plant nutrient mixture from urea and UF-85 in the presence of KOH at 90° C. The products have the drawback of being substantially unstable after 24 hours and often in shorter periods of time. Excessive precipitation occurred after a short while. According to Kealy et al., strict control of time and manufacturing operations, such as initial pH of the suspension, amount of charged solids, urea-to-formaldehyde mole ratio, and reaction time and temperature, help to improve stability of the suspension.

Justice et al. in U.S. Pat. No. 3,462,256 describes the production of aqueous solution of 80-90% partially-reacted urea and formaldehyde by addition of ammonia to an aqueous mixture of partially reacted urea and formaldehyde at 70° C. at pH 8.5-10, then at pH 7-8.5. The clear liquid is said to be stable for 30 days at 20-25° C.

Moore, Jr. in U.S. Pat. No. 4,304,588 describes the formation of a storage-stable, concentrated aqueous solution of nitrogenous compounds derived from the reaction of urea with formaldehyde in a manner whereby the resultant product consists essentially of monomethylene urea (MMU), a small amount of monomethylene diurea (MDU), and unreacted urea. It also contains a substantial amount of hexamethylene tetramine (HMT). U.S. Pat. No. 4,244,727 to Moore, Jr. describes the preparation of clear liquid nitrogenous compounds from reaction of urea and formaldehyde in the presence of phosphoric acid, a buffering agent.

U.S. Pat. No. 4,409,015 to Grace, Jr. describes a two-stage process for preparing an aqueous dispersion of urea-formaldehyde condensation product. In the first stage, an intermediate urea formaldehyde condensation product is prepared by the reaction of urea and formaldehyde at pH 3.5-5.5 and at a temperature of 60-80° C. In the second stage, this intermediate is reacted with urea at pH 3.5 and at 60-80° C. The first stage product is said to contain 18.5% nitrogen and the second stage product 21.5% nitrogen.

Hawkins, in U.S. Pat. Nos. 4,554,005, 4,599,102, 4,776,879, and 4,778,510, describes the preparation of a cyclic nitrogenous compound, triazone, in addition to the linear nitrogenous compounds such as MMU and DMU, by the reaction of urea, aldehyde(s), and ammonia and/or primary amine(s) in two-stage reaction. The triazone is said to be present in at least 30 wt %. This product had a composition suitable for foliar application and sod application devoid of potential burning of foliage and/or sod. The two-stage process involves the use of urea, urea-formaldehyde condensate (UF-85), and ammonia. KOH is used for controlling of the pH during the second stage to maintain pH between 8.7-9.0. A principal drawback with Hawkins is the need for using urea-formaldehyde concentrate, which is difficult and hazardous to handle.

Moore U.S. Pat. No. 4,781,749 describes the preparation of a polymethylene urea solution by a two-stage method. In the first stage, a molar excess of formaldehyde and urea is reacted at 75° C. at pH 7.0 using a buffer such as sodium bicarbonate in the presence of ammonium compounds. In the second stage, the above product is reacted with more urea at pH 6.9-8.5 until the added urea is substantially converted to water-soluble branched chain polymethylene urea compounds which comprise a number of chemical compounds containing 2 to 4 methylene moieties, 2 to 5 urea moieties and 0 to 2 ammonia moieties.

Graves U.S. Pat. No. 5,674,971 reported urea-formaldehyde resin compositions and their preparations. These products were made under alkaline conditions in two to three stages.

It would be desirable to obtain a clear and stable water-soluble plant nutrient in a one-stage process and with a high yield. It would be desirable to prepare a nitrogenous compound that contains a high yield of cyclic nitrogenous compound, particularly up to about 45 wt % triazone. Such a high cyclic nitrogenous content plant nutrient should provide less risk of phytotoxicity toward the plants, as it slowly decomposes to provide the necessary nitrogen to the plants. It also would be desirable to develop a process for preparing a plant nutrient solution which avoids the need for the use of urea-formaldehyde condensate, particularly UF-85, a potential health hazard. It also would be desirable to avoid the need for continuous pH control, which could be accomplished by adding a calculated amount of alkaline material for optimum conversion of urea-formaldehyde adducts to the aforementioned triazone. The nitrogenous plant nutrient preferably should contain very low linear and branched urea-formaldehyde adducts.

### SUMMARY OF INVENTION

The present invention is directed to a one-stage formation of a stable, aqueous plant nutrient solution derived from reaction of urea and formalin with an ammonia reactant to form triazone. The presence of high levels of triazone provides slow degradation of the plant nutrient and slow release of nitrogen to nourish plants. The process of the present invention advantageously avoids the need for the use of urea-formaldehyde condensate, as well as the need for continuous pH control.

The one stage process of the present invention comprises forming a reaction mixture by combining water, urea, formalin, and a sufficient amount of an alkaline material to maintain a pH greater than 7. An ammonia reactant is added to the reaction mixture while heating the reaction mixture, if needed, to maintain a temperature of at least about 90° C. Additional portions of alkaline material then are added to the reaction mixture under conditions sufficient to form an aqueous product solution containing at least one triazone compound, and the product is recovered.

### BRIEF DESCRIPTION OF DRAWINGS

The present invention will now be described in more detail with reference to preferred embodiments of the invention, given only by way of example, and illustrated in the accompanying drawing in which:

FIG. 1 is a graph showing the temperature/pH profile of a typical solution prepared in accordance with the present invention;

FIG. 2 shows a urea molecule;

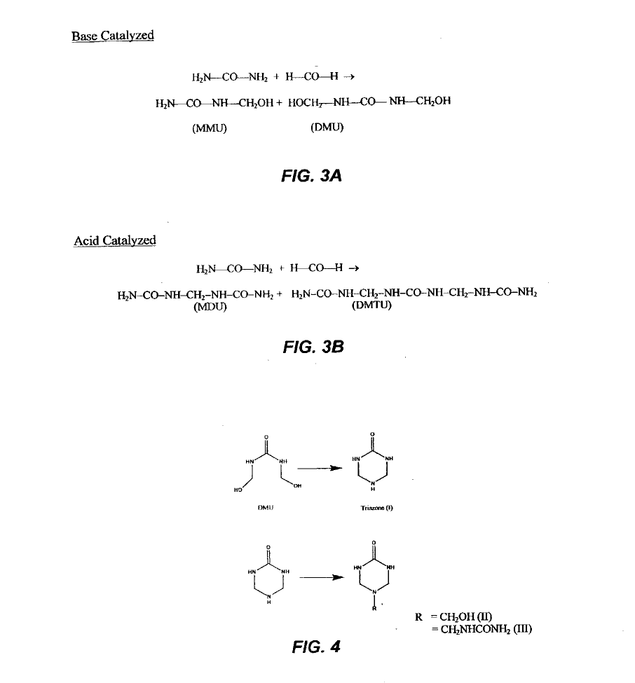

FIGS. 3A and 3B illustrate base-catalyzed and acid-catalyzed reactions with urea and formaldehyde, respectively; and

FIG. 4 illustrates reactions in which triazone is formed.

### DETAILED DESCRIPTION

The present invention is directed to a urea-formaldehyde-ammonia reaction in one stage and under alkaline conditions for the preparation of an aqueous product solution having a high yield and a high content of triazone. The aqueous solution is suitable for use as slow nitrogen-release plant nutrient, which potentially has a substantially lower risk of phytotoxicity to foliar and especially turf sods. The aqueous solution preferably is clear and is free or substantially free of particulates, due to very low contents of linear and branched urea formaldehyde adducts. The solution has a long storage lifetime under normal conditions.

The primary reaction products of formaldehyde and urea are methylolureas. When an excess of formaldehyde is used in strong aqueous solutions (e.g., pH>10), mono, di, tri, and some tetramethylol derivatives are present in the system. Under acidic conditions, these condensate products eventually lead to the formation of complex resins, causing cloudiness and/or thickening of the aqueous solution. Under the base catalyzed reaction at pH 8-10 and a temperature of 70-90° C., the majority of the urea-formaldehyde condensate product is dimethylol urea. Solutions prepared by this method may contain up to about 90% of this adduct. In the presence of ammonium compounds, the aforementioned dimethylol adduct will react to form cyclic triazone moiety.

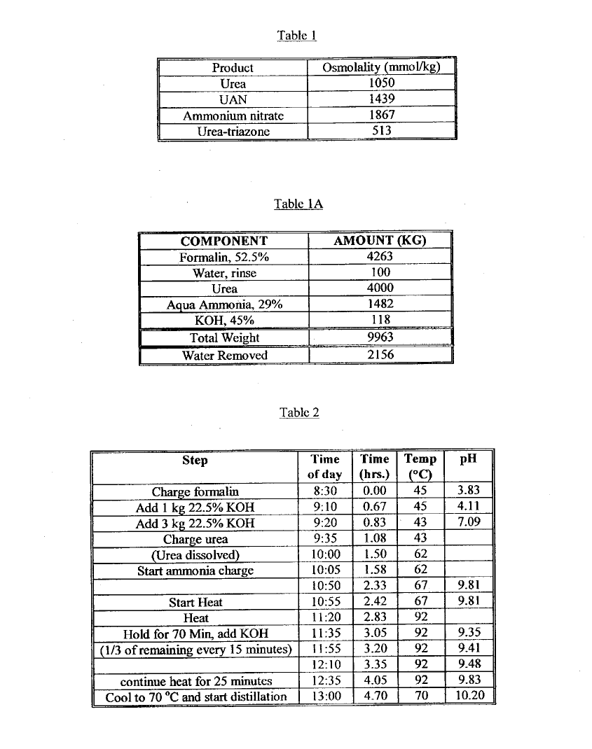

The two reaction schemes of FIG. 3A and FIG. 3B illustrate reactions with urea and formaldehyde for base-catalyzed and acid catalyzed reactions, respectively.

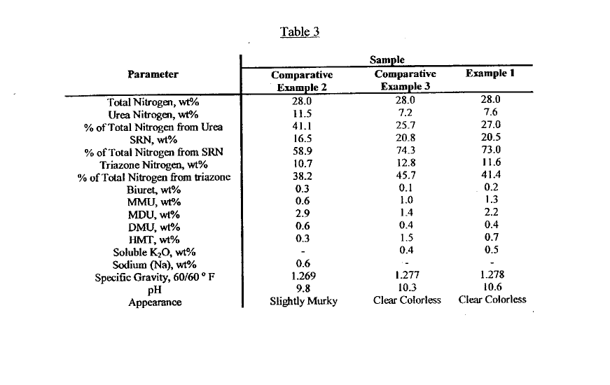

As shown in FIG. 4, in the presence of ammonia (or ammonium compounds) and an excess of formaldehyde, DMU reacts to form the cyclic triazone compound (I) that contains three nitrogen atoms (one from ammonia and two from DMU). The ammonia nitrogen in the ring can undergo further substitution by formaldehyde, urea and/or MMU or DMU (structure II).

The structure of triazone has been proposed by Hawkins to be mainly s-tetrahydrotriazine (I), molecular weight 101, R=H. Tom Murray, in a meeting of the ACS Division of Soil and Fertilizer Chemistry in 1992, proposed its structure to be the 5-methylurea-2-triazone (III), molecular weight of 173, R=—CH₂—NH—CO—NH₂, based on separation and identification by HPLC and FAB.

Factors such as insufficient cook time, low cook temperature, insufficient ammonia, and/or low pH can cause a high MMU content. High DMU content typically is caused by low pH, pH above 11 during cook, and/or insufficient ammonia. Low triazone content often is caused by insufficient formalin, low cook temperature, insufficient cook time, and/or very low or excess ammonia. High-unreacted urea can be caused by such factors as low cook temperature, insufficient cook time, and/or very low or excess ammonia. Excess ammonia can lead to the undesirable formation of hexamethylene tetramine (HMT), a water-insoluble component, by the reaction indicated below.

6HCHO+4NH₃ [symbol] C₆H₁₂N₄HMT

Salt Index, based on soluble or dissolved salts in a plant nutrient, has long been used to estimate the “burn potential” of soil applied plant nutrient but has not proven useful for estimating burn potential of foliarly applied plant nutrient. Osmolality is a measure of osmotic potential of the total dissolved solids in a solution which, in turn, is related to the osmotic pressure across plant tissue surface which may cause cell dehydration with resulting tissue necrosis. There are strong direct correlations between osmolality values and phytotoxic potential of foliar plant nutrients. Table 1 shows the osmolality of urea-triazone solutions containing various ratios of reacted to unreacted urea resulting from dissolving of solid urea in urea-triazone solution. Typical osmolality value for urea-triazone solution is around 500 mmol/kg (i.e., 500 mmol of dissolved solids per kg of solution). The higher the osmolality value the greater the potential for phytotoxicity. The osmolality values for some plant nutrients commonly used for turf are shown in Table 1 below.

The unique structure of triazone supplies 100% of available nitrogen in a slow and controlled release pattern. The low unreacted urea content of the product of the present invention, produced in a single stage, together with the high content of the triazone moiety, makes it an ideal plant nutrient with low burn, even in summertime.

Controlling direction of the product mixture can be accomplished by choosing an appropriate molar ratio between reactants, e.g., formaldehyde, urea, and ammonia, and by reacting them in an alkaline pH, and by proper heating to obtain the maximum amount of DMU for obtaining the maximum amount of triazone. As mentioned above, performing the reaction on acidic pH values or at around neutral pH values will direct the reaction toward formation of linear and branched chain adducts of urea and formaldehyde. The pH should be greater than 7 and preferably ranges from somewhat above 7 to about 9.5. An excess of ammonia may cause the reaction of formaldehyde with ammonia and formation of hexamethylene tetramine (HMT). The higher urea-formaldehyde adducts and HMT are water-insoluble and can undesirably cause the formation of cloudiness and/or precipitates in the aqueous solutions.

In general, the order of addition of the reactants is not critical provided there is no prolonged period of time before adding a final ingredient and provided that there is no imbalance of reactants for any significant period of time during reaction. The ammonia reactant preferably is added slowly to the reaction mixture so that the rise in temperature due to the exotherm can be better controlled.

The aqueous product solution of the present invention preferably contains at least about 30 wt % triazone, more preferably at least about 35 wt %, and even more preferably at least about 40 wt % triazone. The aqueous solution is stable for extended periods under normal storage conditions.

The mole ratio of aldehyde-to-urea most often ranges from about 0.8:1 to about 2:1, preferably is from about 1.1:1 to about 1.2:1, and even more preferably is from about 1.12:1 to about 1.16:1. Formalin, e.g., 30-52% aqueous formaldehyde, may be used for this purpose. Among the advantages of using formalin over the frequently used urea-formaldehyde condensate, particularly UF-85, are the formalin solution's greater stability, ease of use, and reduced health risk, especially when less concentrated solutions are used. Urea may be supplied in any convenient form, such as either pelleted or crystal urea, or as a urea solution. Solid forms of urea are preferred in the practice of the present invention.

The reaction mixture is then made alkaline by addition of a small amount of an alkaline material, e.g., typically on the order of about 1 wt % of the total reaction mixture. Non-limiting examples of alkaline materials that may be used include sodium hydroxide, potassium hydroxide, lithium hydroxide, sodium carbonate and other strong caustic. A preferred alkaline material is potassium hydroxide (KOH), e.g., which may be supplied as a solution in a concentration of about 20-45%. It has been found that a KOH solution in a concentration of about 22.5% provides the greatest ease of use and blendability. Urea is added to the reaction mixture, and the endothermic solution is held, typically at a temperature of about 40° C. to about 55° C., preferably about 45 to about 50° C., until all of the urea dissolves. The ammonia reactant is then added by weight, usually over a period of about 30-45 minutes, and the exothermic solution is allowed to rise in temperature. External temperature is used to keep the mixture at 90-95° C. The mixture typically is held at this temperature for about 60-70 minutes.

The ammonia reactant can be any suitable source of ammonia, such as anhydrous, aqua ammonia, or primary amine. A preferred ammonia reactant is aqua ammonia (ammonium hydroxide). The mole ratio of urea-to-ammonia most often ranges from about 2:1 to 3:1 and preferably is about 2.6:1. The mole ratio of formalin-to-ammonia most often ranges from about 2.5:1 to about 3.5:1 and preferably is about 3:1.

Following addition of the ammonia reactant, additional portions of alkaline material are added, usually sequentially in three portions over the first 45 minutes of a 70-minute cook period. The aqueous solution then is cooled, e.g. to 70° C., and excess water equal to about 28% of the batch weight is removed by distillation.

### EXAMPLES

The following examples are provided to help facilitate a better understanding of the invention and should be regarded as illustrative rather than limiting.

### Example 1

This Example illustrates preparing a triazone-containing plant nutrition solution for slowly releasing nitrogen in accordance with the present invention. Table 1A identifies the components and their respective quantities used to prepare the solution.

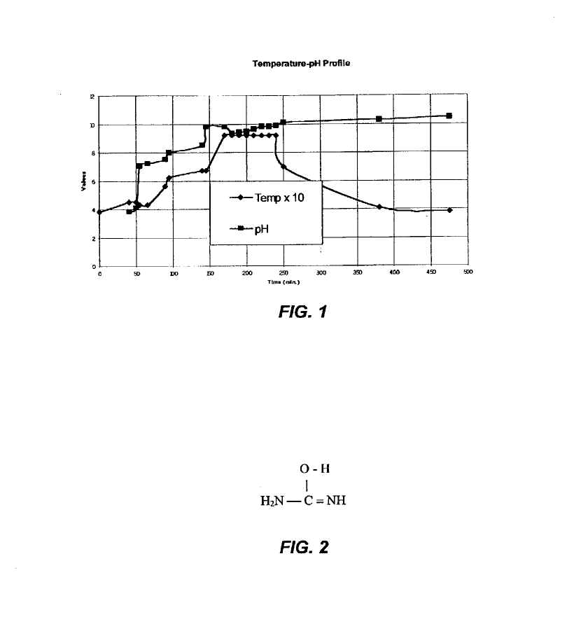

The formalin was charged into a reactor, followed by the rinse water. The pH was then adjusted with KOH to 7-7.5. Urea was charged, and the mixture was held at 45-50° C. until the urea dissolved. The aqua ammonia was metered over 30-45 minutes, and then the mixture was heated to 92° C. for 70 minutes. The remaining KOH was charged in three portions over the first 45 minutes during the 70-minute cook period. The batch was then cooled, and stripping of excess water by distillation began when the temperature reached about 70° C. About 28% of the batch size by weight was stripped. The parameters and steps are summarized in Table 2 below. The temperature-pH profile of a typical batch is shown in FIG. 1.

### Comparative Examples 2-3

Solutions described in Moore, U.S. Pat. No. 4,781,749 and Hawkins, U.S. Pat. No. 4,599,102 were prepared for comparison to the solution of Example 1. Comparative Example 2 was prepared essentially as described in Example 1 of U.S. Pat. No. 4,781,749. Comparative Example 3 was prepared essentially as described in Example 1 of U.S. Pat. No. 4,599,102. The compositions of each solution were determined by HPLC. Table 3 summarizes the compositions of the three solutions.

The percentage of urea nitrogen is an indication of unreacted urea in the system. This is about 12% in Comparative Example 2, while about 7-8% in Comparative Example 3 as well as in Example 1. The percent of Slow Release Nitrogen in Comparative Example 2 is 17%, while in Example 1 and Comparative Example 2 are about 21%, which is indicative of higher levels of triazone. This also is apparent from percent of total nitrogen from triazone in the three solutions. Although the composition of Comparative Example 3 is somewhat similar to that of Example 1, a key drawback with the former is that its preparation requires the use of urea-formaldehyde concentrate (UFC or UF-85) which is a hazardous chemical, expensive, and difficult to handle.

The principles, preferred embodiments and modes of operation of the present invention have been described in the foregoing specification. The invention which is intended to be protected herein, however, is not to be construed as limited to the particular forms disclosed, since they are to be regarded as illustrative rather than restrictive. Variations and changes may be made by those skilled in the art without departing from the spirit of the invention.

1. A one-stage process of preparing a triazone-containing plant nutrition solution for slowly releasing nitrogen, the process comprising:
(i) forming a reaction mixture by combining water, urea, formalin, and a sufficient amount of an alkaline material to maintain a pH greater than 7;
(ii) adding to said reaction mixture an ammonia reactant while heating the reaction mixture, if needed, to maintain a temperature of at least about 90° C.;
(iii) sequentially adding to said reaction mixture additional portions of alkaline material under conditions sufficient to form an aqueous product solution containing at least one triazone compound; and
(iv) recovering the product.

2. The process of claim 1 wherein said alkaline material is selected from the group consisting of sodium hydroxide, potassium hydroxide, lithium hydroxide, and sodium carbonate.

3. The process of claim 2 wherein said alkaline material is potassium hydroxide.

4. The process of claim 1 wherein said step of forming a reaction mixture comprises maintaining a temperature of about 40° C. to about 55° C.

5. The process of claim 4 wherein said temperature is from about 45° C. to about 50° C.

6. The process of claim 1 wherein said step of adding additional portions of said alkaline material comprises heating said reaction mixture to a temperature of about 90° C. to about 95° C.

7. The process of claim 1 wherein said step of adding additional portions of said alkaline material comprises sequentially adding at least three portions of said alkaline material to said reaction mixture.

8. The process of claim 1 wherein the product contains at least about 30 wt % of said at least one triazone compound.

9. The process of claim 8 wherein the product contains at least about 35 wt % of said at least one triazone compound.

10. The process of claim 9 wherein the product contains at least about 40 wt % of said at least one triazone compound.

11. A one-stage process of preparing a plant nutrition solution containing at least about 40 wt % of triazone for slowly releasing nitrogen, the process comprising:
(i) forming a reaction mixture by combining water, urea, formalin, and a sufficient amount of potassium hydroxide to maintain a pH greater than 7 to about 9.5, while maintaining a temperature of from about 45° C. to about 50° C.;
(ii) adding to said reaction mixture aqua ammonia while heating the reaction mixture, if needed, to maintain a temperature of about 90° C. to about 95° C.;
(iii) sequentially adding to said reaction mixture at least three additional portions of potassium hydroxide under conditions sufficient to form an aqueous product solution containing at least one triazone compound; and
(iv) recovering the product, wherein the product solution contains at least about 40 wt % of said at least one triazone compound.
